(19) United States
(12) Patent Application Publication
(10) Pub. No.: US 2011/0022630 A1
(43) Pub. Date: Jan. 27, 2011

(54) SECURE VIRTUAL PLATFORM FOR QUERYING WIDGETS

(76) Inventor: Srinivas Gupta MADISHETTY, Sunnyvale, CA (US)

Correspondence Address: EVERGREEN VALLEY LAW GROUP, 4 N 2nd Street, Suite 598, SAN JOSE, CA, 95113, US

(21) Appl. No.: 12/507,804

(22) Filed: Jul. 23, 2009

(51) Int. Cl. G06F 17/30

(52) U.S. Cl. 707/770; 707/E17.014

(57) ABSTRACT

Secure virtual platform for querying widgets. A method includes receiving, electronically, an input associated with one or more widgets. The method also includes asynchronously forwarding the input to the one or more widgets. Further, the method includes electronically retrieving contents associated with the input from the one or more widgets. Moreover, the method includes displaying the contents corresponding to the one or more widgets.

### BACKGROUND

In the current scenario, a user can choose a multitude of widgets with predefined capabilities based on requirements of the user. The user can also personalize and customize the widgets based on the user's preferences. However, the user may not able to query the widgets to obtain content. Further, scope of the content provided by the widgets may be limited by the predefined capabilities of the widgets.

Framework of the widgets includes a sandbox for providing stand alone security corresponding to widgets from unverified third-parties, suppliers and untrusted users. However, the sandbox may not be able to provide security from all malicious content associated with the widgets. Further, the sandbox may not be able to monitor inappropriate interactions among the widgets.

In light of foregoing discussion there is a need for a technique for providing a secure virtual platform for querying widgets.

### SUMMARY

Embodiments of the present disclosure described herein provide a method, system, and article of manufacture for a secure virtual platform for querying widgets.

An example of an article of manufacture includes a machine-readable medium. The machine-readable medium carries instructions operable to cause a programmable processor to perform receiving, electronically, an input associated with one or more widgets. The machine-readable medium also carries instructions operable to cause a programmable processor to perform asynchronously forwarding the input to the one or more widgets. Further, the machine-readable medium carries instructions operable to cause a programmable processor to perform electronically retrieving contents associated with the input from the one or more widgets. Moreover, the machine-readable medium carries instructions operable to cause a programmable processor to perform displaying the contents corresponding to the one or more widgets.

Another example of an article of manufacture includes a machine-readable medium. The machine-readable medium carries instructions operable to cause a programmable processor to perform receiving, electronically, an input associated with one or more widgets. The machine-readable medium also carries instructions operable to cause a programmable processor to perform electronically querying one or more remote content sources associated with the one or more widgets in response to the input. Further, the machine-readable medium carries instructions operable to cause a programmable processor to perform electronically retrieving contents from the one or more remote content sources. Moreover, the machine-readable medium carries instructions operable to cause a programmable processor to perform displaying the contents corresponding to the one or more widgets.

An example of a method includes receiving, electronically, an input associated with one or more widgets. The method also includes asynchronously forwarding the input to the one or more widgets. Further, the method includes electronically retrieving contents associated with the input from the one or more widgets. Moreover, the method includes displaying the contents corresponding to the one or more widgets.

An example of a system includes links to one or more remote content sources and a communication interface in electronic communication with the one or more remote content sources to retrieve contents through the link. The system also includes a memory that stores instructions. Further, the system includes a processor responsive to the instructions to receive, electronically, an input associated with one or more widgets, asynchronously forward the input to the one or more widgets, electronically retrieve contents associated with the input from the one or more widgets, and display the contents corresponding to the one or more widgets. Furthermore, the system includes a storage unit for storing and categorizing one or more widgets.

### BRIEF DESCRIPTION OF THE DRAWINGS

FIG. 1 is a block diagram of an environment, in accordance with which various embodiments can be implemented;

FIG. 2 is a block diagram of a server, in accordance with one embodiment;

FIG. 3 is a flowchart illustrating a method for querying widgets, in accordance with one embodiment;

FIGS. 4a and 4b exemplarily illustrate a secure virtual platform for retrieving contents corresponding to widgets from different remote content sources, in accordance with one embodiment; and

FIGS. 5a and 5b exemplarily illustrate a secure virtual platform for retrieving contents corresponding to widgets from different remote content sources.

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

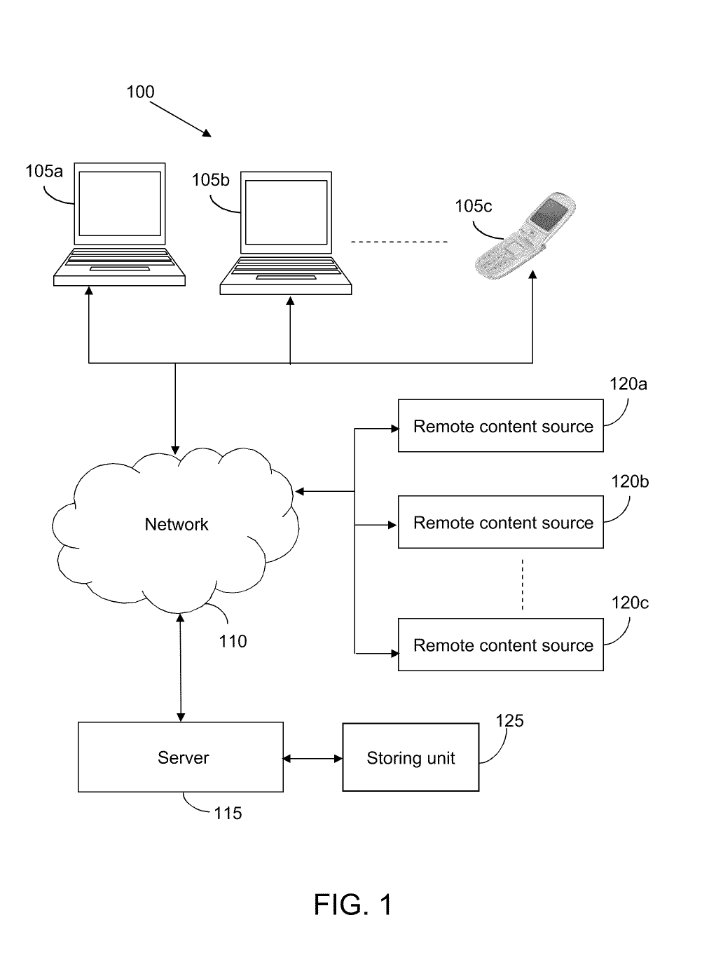

FIG. 1 is a block diagram of an environment 100, in accordance with which various embodiments can be implemented. The environment 100 includes a plurality of user devices 105a, 105b, and 105c. Examples of user devices include, but are not limited to, computers, laptops, mobile devices, hand held devices, telecommunication devices and personal digital assistants (PDAs). The user devices 105a, 105b, and 105c are connected to a server 115 through a network 110. Examples of the network 110 include but are not limited to a Local Area Network (LAN), a cloud computing network, a Wireless Local Area Network (WLAN), a Wide Area Network (WAN), internet and a Small Area Network (SAN). The network 110 can also include a telecommunication network for linking to the telecommunication devices.

In various embodiments, the user devices correspond to the user devices of multiple users.

The server 115 facilitates creation, customization, storage, rendering and sharing of one or more widgets. The widgets can be also created using the user devices. The widgets created using a user device, for example, 105a, can be rendered to or shared with other user devices for example, 105b and 105c. Each widget is associated with a remote content source. Examples of remote content sources include, but are not limited to, websites, search engines, and telecommunication servers. The server 115 includes links to remote content sources, for example, 120a, 120b, and 120c, associated with the widgets.

In some embodiments, the links to the remote content sources can be provided by a user corresponding to the widgets created by the user using a user device, for example, 105a.

In some embodiments, the server can be in communication with a storing unit 125. The storing unit 125 stores the widgets. The server 115 provides the widgets to the user devices, for example, user device 105a, from repository of the widgets in the storing unit 125.

In some embodiments, the widgets provided by the server 115 can be selected by a user using a user device, for example, 105a.

The server 115 receives an input associated with the widgets from the user devices. The input includes, but is not limited to, user profile information, a search query made by the user, keyword, multimedia content, a document, user history, and user activity. The server 115 forwards the input to the widgets. The server 115 retrieves contents associated with the input from the one or more widgets. The server 115 retrieves the contents from the remote content sources using the links corresponding to the widgets. The contents include, but are not limited to, text contents, multimedia contents, and web pages.

In some embodiments, the server 115 can retrieve the contents from the remote content sources using a remote server (not shown in Figures) or a search engine.

The server 115 displays the contents corresponding to the one or more widgets on the user devices. The server 115 can display the contents based on priority and category associated with the widgets. The server 115 can display the contents corresponding to the widgets on a virtual platform, for example, a web page, rendered on the user device 105a. The contents corresponding to the widgets can be organized or altered on the virtual platform based on the priority, the category, and preference of a user.

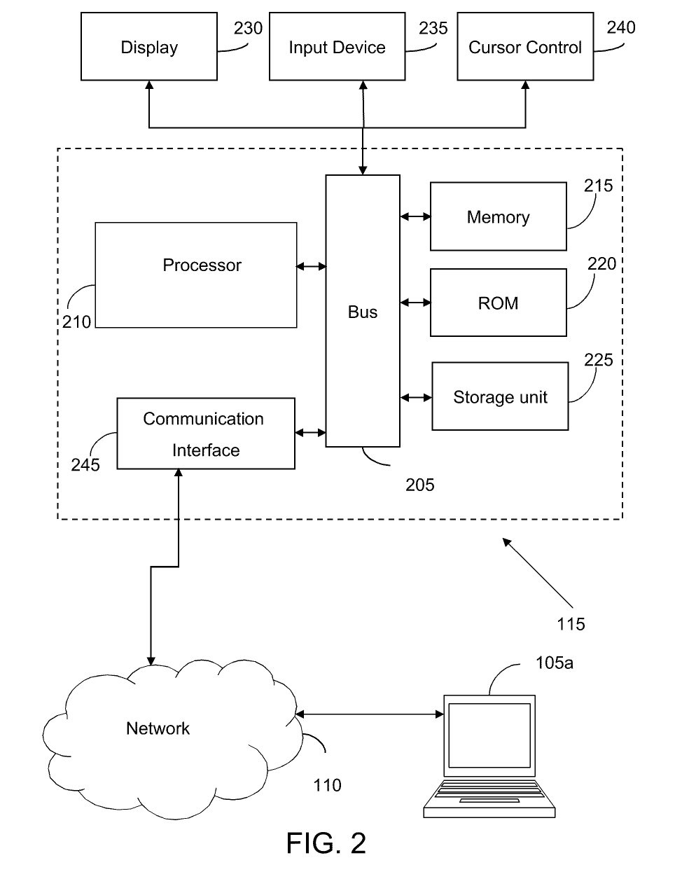

FIG. 2 is a block diagram of a server, in accordance with one embodiment. The server includes a bus 205 for communicating information and a processor 210 coupled with the bus 205 for processing the information. The server also includes a memory 215 for example a random access memory (RAM) coupled to the bus 205 for storing information required by the processor 210. The memory 215 can be used for storing temporary information required by the processor 210. The server 115 further includes a read only memory (ROM) 220 coupled to the bus 205 for storing static information required by the processor 210. A server storage unit 225, for example a magnetic disk, hard disk or optical disk, can be provided and coupled to bus 205 for storing information.

The server 115 can be coupled via the bus 205 to a display 230, for example a cathode ray tube (CRT) or liquid crystal display (LCD), for displaying information. An input device 235, including various keys, is coupled to the bus 205 for communicating information to the processor 210. In some embodiments, cursor control 240, for example a mouse, a trackball, a joystick, or cursor direction keys for communicating information to the processor 210 and for controlling cursor movement on the display 230 can also be present.

In one embodiment, the steps of the present disclosure are performed by the server 115 using the processor 210. The information can be read into the memory 215 from a machine-readable medium, for example the server storage unit 225. In alternative embodiments, hard-wired circuitry can be used in place of or in combination with software instructions to implement various embodiments.

The term machine-readable medium can be defined as a medium providing data to a machine to enable the machine to perform a specific function. The machine-readable medium can be storage medium. Storage media can include non-volatile media and volatile media. The server storage unit 225 can be non-volatile media. The memory 215 can be a volatile medium. All such media must be tangible to enable the instructions carried by the media to be detected by a physical mechanism that reads the instructions into the machine.

Examples of the machine readable medium includes, but are not limited to, a floppy disk, a flexible disk, hard disk, magnetic tape, a CD-ROM, optical disk, punchcards, papertape, a RAM, a PROM, EPROM, and a FLASH-EPROM.

The server 115 also includes a communication interface 245 coupled to the bus 205 for enabling data communication. Examples of the communication interface 245 include, but are not limited to, an integrated services digital network (ISDN) card, a modem, a local area network (LAN) card, an infrared port, a Bluetooth port, a zigbee port, and a wireless port.

In some embodiments, the processor 210 receives an input associated with one or more widgets. Further, the processor forwards the input to the one or more widgets asynchronously. Furthermore, the processor retrieves contents associated with the input from the one or more widgets and displays the contents corresponding to the one or more widgets.

In some embodiments, the processor 210 can include one or more processing units for performing one or more functions of the processor 210. The processing units are hardware circuitry performing specified functions.

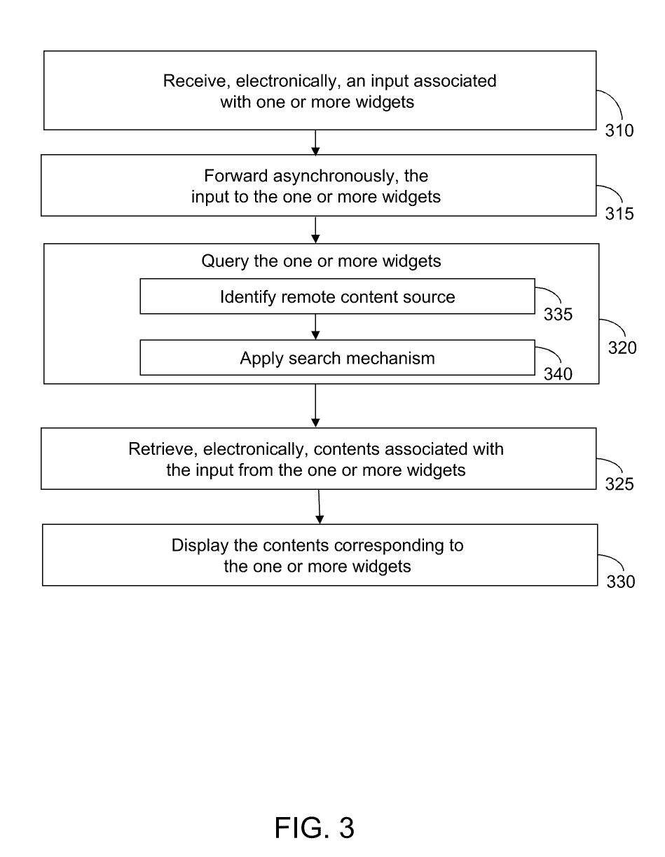

FIG. 3 illustrates a flow chart of a method for querying widgets, in accordance with one embodiment.

A secure virtual platform for querying widgets is provided. Examples of the secure virtual platform can include, but are not limited to, a webpage, an application user interface, and a widget tool bar.

At step 310, an input associated with one or more widgets is received electronically. The input includes, but is not limited to, user profile information, a search query made by a user, keyword, multimedia content, a document, user history, and user activity. For example, a keyword “Sports” is received from the user on the webpage to query the widgets with contents corresponding to the keyword “Sports”.

At step 315, the input is forwarded to the widgets asynchronously. A repository of widgets is searched and the widgets associated with the input are identified. For example, if the keyword “Sports” is received from the user, the repository is searched for widgets with contents corresponding to the keyword “Sports”. The widgets identified for the keyword “Sports” can include, but not limited to, widgets providing live sports streaming, widgets providing sports related articles, and widgets providing news related to sports.

The widgets stored in the repository can be created previously. Each widget is linked to a remote content source. Several widgets can be linked to the remote content source. Examples of remote content sources include, but are not limited to, websites, search engines, and telecommunication servers. The widgets are input sensitive. Each widget created can be directed to perform predefined functions in response to the receipt of the input. The predefined functions can include, but are not limited to, identifying 335 the remote content source linked with the widget, applying a search mechanism 340 for retrieving contents from the remote content source, querying 320 the remote content source, and retrieving contents from the remote content source. Exemplarily, a query string can be formulated for each widget to include the input received and retrieve contents associated with the input from the remote content source linked to the widget. For example, a sports live widget providing live sports streaming content can be created and linked to remote content sources, ESPN website, TEN SPORTS website, and STAR SPORTS website. The widget can be directed to query the remote content sources for availability of live streaming content associated with sports to provide a live stream on the sports live widget in response to the input.

In some embodiments, the widgets can be created by multiple users. The users can also provide links to the remote content sources corresponding to the widgets. The users can also be provided with options to select multiple layouts, colors, graphics and other customization features to prefix appearance of the widgets and contents in the widgets on the secure virtual platform. The users can utilize the customization features to create multiple templates for displaying the widgets and the contents in the widgets on the secure virtual platform. Alternatively, multiple default templates can be also be provided to the users. A user can also select templates created by other users for applying the customization features corresponding to the template to the widgets created by the user. Selection of each template created corresponds to applying customization features associated with the template.

The widgets created can be tested for compilation, loading of contents in the widgets in response to the input, and display of the widgets with contents associated with the input. Several inputs, for example, keywords can be used to test the widgets. The contents in the widgets and the templates associated with the widgets can be validated upon running the test.

In some embodiments, the widgets created can be modified and optimized after one or more tests. Each widget created can be retained as a test widget in development or deployed as a public widget. A widget retained as a test widget by a user may not be accessible to other users of the secure virtual platform while a widget deployed as a public widget can be made accessible to other users.

In some embodiments, the widgets are categorized based on the contents provided by the widgets. Examples of the categories include, but are not limited to, “articles”, “photos”, “videos”, “stocks”, “sports”, “hobbies”, “horoscopes”, “games”, and “education”. For example, a widget providing images received from a photography website is associated with the “photos” category. Each widget can be associated with one or more categories based on the content provided by the widget. The categories can also be stored. The categories can also be provided to the users as default to enable the users to associate the widgets created with a category among the default categories provided.

In response to the input, widgets providing content associated with the input can be searched and identified in each category. For example, for a keyword “Sports”, the widgets in “articles”, “images”, and “videos” categories can be searched. A sports news widget can be identified in the “articles” category, a sports illustrated widget can be identified in the “photos” category, and a sports live widget can be identified in the “videos” category. Widgets in other categories with content associated with the input can also be searched. The input can then be forwarded to the widgets identified.

At step 325, contents associated with the input are electronically retrieved from the widgets. The predefined functions associated with the widgets, including identifying the remote content source linked with each widget, applying a search mechanism for retrieving contents from the remote content source, and querying the remote content source, can be executed in response to the input. The search mechanism can include, but is not limited to, incorporating links to the remote content source and incorporating the input in the query string formulated for the widget. The query string is directed to the remote content source for querying the remote content source. The remote content source is searched for contents corresponding to the input incorporated in the query string.

The contents associated with the input are subsequently retrieved from the remote content source by each widget. The contents from each widget are then retrieved. A widget container is provided for the each of the widgets. The widget container includes, but is not limited to, namespaces for each widget. The contents retrieved from each widget are pooled in a namespace provided for the widget. The contents pooled in each namespace are sorted using the widget container. The sorting can be based on, but is not limited to, prioritization of the widgets corresponding to each category and trustworthiness of the remote content sources linked with the widgets. The widgets in each category can be prioritized based on, but not limited to, quality of the contents retrieved from the remote content sources linked to the widgets, relevance of the contents retrieved corresponding to the input, and popularity of remote content sources linked to the widgets. The trustworthiness can be ascertained by verifying authenticity and standard security certificates associated with each remote content source. The widget container provides security to the virtual platform and also retains privacy of user data by preventing sharing of contents retrieved or queries made, among the widgets. The contents are then rendered corresponding to the widgets based on the sorting.

At step 330, the contents corresponding to the widgets are displayed. The widgets and the contents in the widgets can be displayed on the secure virtual platform, for example, a webpage. Each widget can also be displayed in the template associated with the widget.

In some embodiments, the contents can be displayed based on but not limited to, order of the priority of the widgets, the category associated with the widgets, and order of priority of the widgets in each category. Each widget and contents retrieved corresponding to the widget can be maximized and displayed in full view on the secure virtual platform. The contents in each widget can be scrollable and widgets in each category can be scrollable.

In some embodiments, the widgets can be selected randomly or based on predefined selection parameters, connection can be established with the remote content sources linked to the widgets selected, default contents corresponding to the widgets can be obtained from the remote content sources, the default contents obtained can be validated by the container. The default contents corresponding to the widgets selected can then be displayed on the secure virtual platform at an instance.

In some embodiments, only the contents can be directly displayed on the secure virtual interaction platform without the limitation of displaying the contents within widget. The contents can be displayed in order of the priority of the widgets and corresponding to each category associated with the widgets.

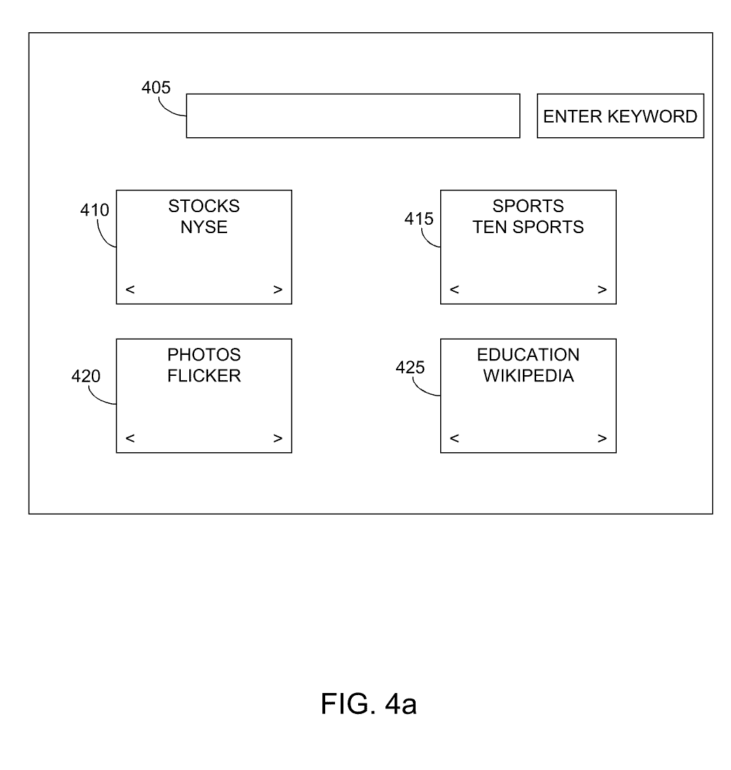

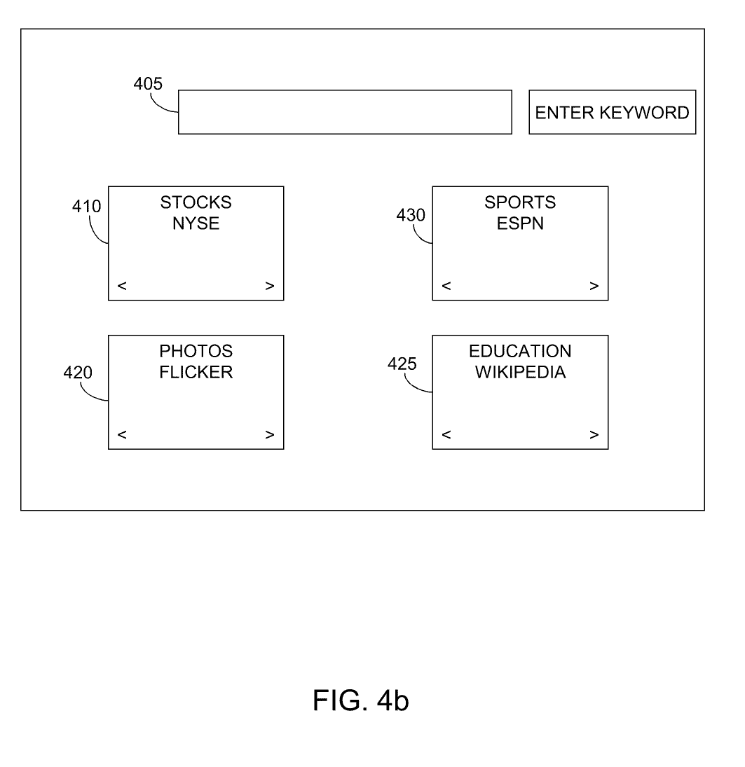

FIGS. 4a and 4b exemplarily illustrate a secure virtual platform for retrieving contents corresponding to widgets from different remote content sources.

The user interface of the secure virtual platform includes a text input receiver 405. A user provides an input using the text input receiver 405. The user confirms the text input by pressing a button called “ENTER KEYWORD” on the screen, through an input device. The input device may be one of a mouse, keyboard, a touch screen, a voice capturing device and a camera device.

The categories “stocks”, “sports”, “photos” and “education” associated with widgets can be selected by the user for displaying the widgets and contents in the widgets in the categories selected. The widgets in each category can also be presented to the user can default. The widget “NYSE” 410 and its contents are displayed corresponding to the category “STOCKS”. The widget “ESPN” 415 and its contents are displayed corresponding to the category “SPORTS”. The widget 430 is linked to a remote content source of “ESPN”. The widget “FLICKR” 420 and its contents are displayed corresponding to the category “PHOTOS”. The widget “WIKIPEDIA” 425 and its contents are displayed corresponding to the category “EDUCATION”.

The user is provided with a clickable next (>) button and a clickable previous (<) button corresponding to each category of widgets for at least one of scrolling contents in each widget or scrolling widgets in each category.

If the user provides the next option, the widget “ESPN” 415 is replaced with the widget “TEN SPORTS” 430 as illustrated in FIG. 4b. The widget 430 is linked to the remote content source of “TEN SPORTS”.

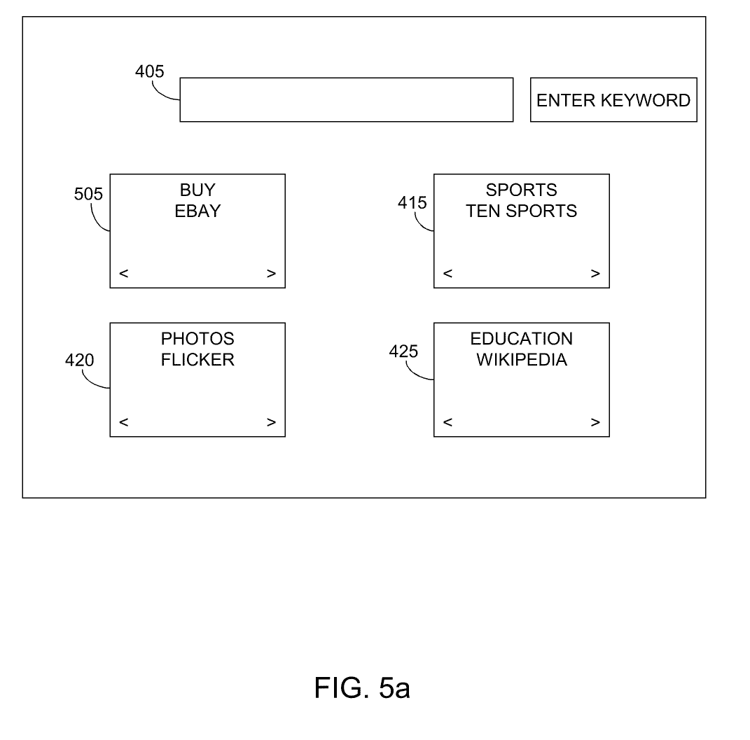

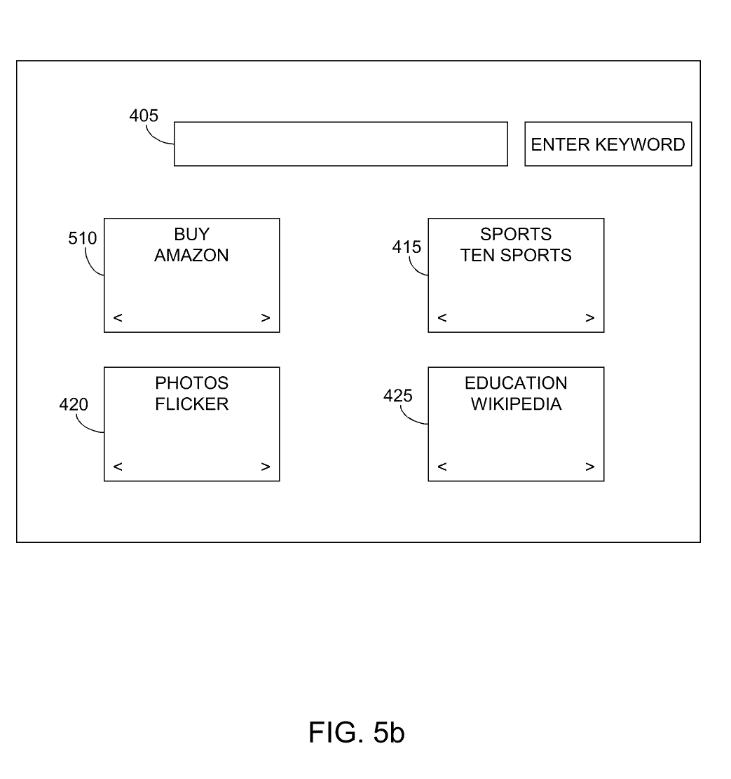

FIGS. 5a and 5b exemplarily illustrate a secure virtual platform for retrieving contents corresponding to widgets from different remote content sources.

The user interface of the secure virtual platform includes a text input receiver 405. A user provides an input using the text input receiver 405. The user confirms the text input by pressing a button called “ENTER KEYWORD” on the screen, through an input device. The input device may be one of a mouse, keyboard, a touch screen, a voice capturing device and a camera device.

The categories “buy”, “sports”, “photos” and “education” associated with widgets can be selected by the user for displaying the widgets and contents in the widgets in the categories selected. The widgets in each category can also be presented to the user can default. The widget “ebay” 505 and its contents are displayed corresponding to the category “buy”. The widget “Ten Sports” 415 and its contents are displayed corresponding to the category “SPORTS”. The widget 415 is linked to a remote content source of “Ten Sports”. The widget “FLICKR” 420 and its contents are displayed corresponding to the category “PHOTOS”. The widget “WIKIPEDIA” 425 and its contents are displayed corresponding to the category “EDUCATION”.

If the user clicks on the next button (>), in FIG. 5b, the widget 505 is replaced with the widget 510. The widget 405 is linked to the remote content source of “ebay” and the widget 510 is linked to the remote content source of “Amazon”.

If the user provides the input as a key word “laptop”. The displayed widget 505 may provide “ebay” widget with the search results for the keyword “laptop”. The user may browse with the “ebay” website through the widget 505. The user may have to provide confidential details such as user name, credit card details, user's e-mail address and user's postal address to purchase a laptop or any other goods from “ebay” website. The confidential details are not shared with other widgets and are not shared with other widget category. The security of the confidential details is maintained by pooling the widgets in each namespaces within a single widget container.

In some embodiments, the user selects widgets in which the contents are to be displayed. The server performs the search in the content servers associated with the selected widgets. The server will also perform a search in other content server which are not associated with the selected widgets. If, the server identifies more relevant contents from the content servers which are not associated with the selected widgets, then the server will prompt the user to access or reject the prompt to display such content. The prompts may be provided based on one of a content ranking of the content servers, number of hits the content servers experience and a rating of the widgets.

For example, a user may wish to perform a search operation for a keyword “Michael Jackson” in the selected widgets. The intension of the user might be to access photographs related to the keyword “Michael Jackson”. The selected widgets include an ebay widget (online buy and sell widget), a BBC widget (a news widget) and a Ten Sports widget (a sports widget). The contents relating to the keyword “Michael Jackson” from the ebay content server, the BBC content server and the Ten Sports content server are displayed. However, a prompt is also provided to the user to access widgets and the corresponding contents with photographs relating to the keyword “Michael Jackson”.

While exemplary embodiments of the present disclosure have been disclosed, the present disclosure may be practiced in other ways. Various modifications and enhancements may be made without departing from the scope of the present disclosure. The present disclosure is to be limited only by the claims

What is claimed is:

1. An article of manufacture comprising:
a machine-readable medium; and
instructions carried by the medium and operable to cause a programmable processor to perform:
receiving, electronically, an input associated with one or more widgets;
asynchronously forwarding the input to the one or more widgets;
electronically retrieving contents associated with the input from the one or more widgets; and
displaying the contents corresponding to the one or more widgets.

2. The article of manufacture of claim 1, wherein the retrieving comprises:
electronically querying one or more remote content sources.

3. The article of manufacture of claim 1, wherein the forwarding comprises:
searching a repository of the one or more widgets; and
identifying the one or more widgets associated with the input.

4. The article of manufacture of claim 1 further comprising:
creating the one or more widgets;
categorizing the one or more widgets; and
prioritizing the one or more widgets corresponding to each category.

5. The article of manufacture of claim 4, wherein the creating comprises:
identifying a remote content source corresponding to each widget; and
applying a search mechanism for retrieving the contents from the remote content source in response to the input.

6. The article of manufacture of claim 1, wherein the displaying comprises:
displaying the one or more widgets in order of priority; and
displaying the one or more widgets corresponding to a category associated with the one or more widgets.

7. The article of manufacture of claim 1, further comprising:
providing a widget container for the one or more widgets; and
creating namespaces for each widget in the widget container.

8. The article of manufacture of claim 7 further comprising instructions operable to cause the programmable processor to perform:
pooling contents retrieved from the one or more widgets in each namespace;
sorting the contents pooled in each namespace using the widget container; and
rendering the contents corresponding to the one or more widgets based on the sorting.

9. An article of manufacture comprising:
a machine-readable medium; and
instructions carried by the medium and operable to cause a programmable processor to perform:
receiving, electronically, an input associated with one or more widgets;
electronically querying one or more remote content sources associated with the one or more widgets in response to the input;
electronically retrieving contents from the one or more remote content sources; and
displaying the contents.

10. The article of manufacture of claim 9, wherein the displaying comprises:
displaying the contents in order of priority; and
displaying the contents corresponding to a category associated with the one or more widgets.

11. A method comprising:
receiving, electronically, an input associated with one or more widgets;
asynchronously forwarding the input to the one or more widgets;
electronically retrieving contents associated with the input from the one or more widgets; and
displaying the contents corresponding to the one or more widgets.

12. The method of claim 11, wherein the retrieving comprises:
electronically querying one or more remote content sources.

13. The method of claim 11, wherein the forwarding comprises:
searching a repository of the one or more widgets; and
identifying the one or more widgets associated with the input.

14. The method of claim 11 further comprising:
creating the one or more widgets;
categorizing the one or more widgets; and
prioritizing the one or more widgets corresponding to each category.

15. The method of claim 14, wherein the creating comprises:
identifying a remote content source corresponding to each widget; and
applying a search mechanism for retrieving the contents from the remote content source in response to the input.

16. The method of claim 11, wherein the displaying comprises:
displaying the one or more widgets in order of priority; and
displaying the one or more widgets corresponding to a content category.

17. The method of claim 11, further comprising:
providing a widget container for the one or more widgets; and
creating namespaces for each widget in the widget container.

18. The method of 17 further comprising instructions operable to cause the programmable processor to perform:
pooling the contents retrieved from the one or more widgets in each namespace;
sorting the contents pooled in each namespace using the widget container; and
rendering the contents corresponding to the one or more widgets based on the sorting.

19. A system comprising:
links to one or more remote content sources;
a communication interface in electronic communication with the one or more remote content sources to retrieve contents through the links;
a memory that stores instructions; and
a processor responsive to the instructions to:
receive, electronically, an input associated with one or more widgets;
asynchronously forward the input to the one or more widgets;
electronically retrieve contents associated with the input from the one or more widgets, wherein the one or more widgets are in communication with the one or more remote content sources through the links; and
display the contents corresponding to the one or more widgets.

20. The system of claim 19 further comprising:
a storage unit for storing one or more widgets.
